(19) United States
(12) Patent Application Publication
(10) Pub. No.: US 2008/0042977 A1
(43) Pub. Date: Feb. 21, 2008

(54) SYSTEM AND METHOD FOR CONTROLLING DEVICE OPERATIONS WITH A JOYSTICK

(75) Inventors: Chih-Kuang Chang, Tu-Cheng (TW); Wei-Qi Sun, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/681,194

(22) Filed: Mar. 2, 2007

(30) Foreign Application Priority Data
Aug. 18, 2006 (TW) 95130442

(51) Int. Cl. G06F 3/033

(52) U.S. Cl. 345/161

(57) ABSTRACT

A system for controlling device operations with a joystick includes: a computer (10) connects to the device (2), a joystick (4) and a control panel (5) connect to the computer through a control circuit (3); the computer is configured for configuring a predetermined data format of data transmissions between the computer and the control circuit; the control circuit is configured for receiving switch status signals from the control panel and the joystick input signals, digitalizing and encoding the switch status signals and the joystick input signals to a data packet according to the predetermined data format, and sending the data packet to the computer, the joystick input signals including/containing/reflecting directional inputs of the joystick, the directional inputs including a backward directional input, a forward directional input, a left directional input, a right directional input, and a rotational input; the joystick is configured for receiving the directional inputs and for generating the joystick input signals accordingly; and the computer is further configured for decoding the data packet according to the predetermined data format in order to extract the switch status signals and the joystick input signals for generating device control instructions so as to operate the device. A related method is also disclosed.

### BACKGROUND OF THE INVENTION

1. Field of the Invention

The present invention relates to a system and method for controlling device operations with joystick.

2. Description of Related Art

Machines may have many different functions, and thus, may have many control devices. For example, machines may have many levers, buttons, switches, pedals, etc. that may be manipulated in order to control the different functions of the machine. In addition, some machines may also include separate steering input devices. In many cases, the steering input device may be a joystick, particularly if the machine has ground speeds (i.e., machines configured to travel between worksites).

The machines include coordinate measuring machines or video game consoles. The joystick is a hand held controller, for example, an industry handle, a game pad . . . etc.

Movements of the machine is driven by a motor that is controlled by the joystick. Usually, undesired and inaccurate movements such as wobbling and stuttering are a result of mechanical errors, mechanical delay, and/or human mishandling of the joystick. Therefore, there is a need to provide a joystick system so that the joystick can promptly and errorlessly control the electric motor to start and stop, and can adjust the speed of the elector motor by a large level but the work machine cannot wobble.

### SUMMARY OF THE INVENTION

A system for controlling device operations with a joystick includes: a computer connects to the device, a joystick and a control panel connect to the computer through a control circuit; the computer is configured for configuring a predetermined data format of data transmissions between the computer and the control circuit; the control circuit is configured for receiving switch status signals from the control panel and the joystick input signals, digitalizing and encoding the switch status signals and the joystick input signals to a data packet according to the predetermined data format, and sending the data packet to the computer, the joystick input signals including/containing/reflecting directional inputs of the joystick, the directional inputs including a backward directional input, a forward directional input, a left directional input, a right directional input, and a rotational input; the joystick is configured for receiving the directional inputs and for generating the joystick input signals accordingly; and the computer is further configured for decoding the data packet according to the predetermined data format in order to extract the switch status signals and the joystick input signals for generating device control instructions so as to operate the device.

A computer-based method for controlling device operations with a joystick includes the steps of: configuring a predetermined data format of data transmissions between a computer and a control circuit; receiving switch status signals from a control panel and joystick input signals by the control circuit, the joystick input signals including/containing/reflecting directional inputs of the joystick, the directional inputs including a backward directional input, a forward directional input, a left directional input, a right directional input, and a rotational input; encoding the joystick input signals and the switch status signals into a data packet according to the predetermined data format and sending the data packet to the computer; and decoding the data packet by the computer according to the predetermined data format in order to extract the joystick input signals and the switch status signals for generating device control instructions so as to operate the device connected to the computer.

Other advantages and novel features of the present invention will become more apparent from the following detailed description of preferred embodiments when taken in conjunction with the accompanying technical drawings.

### BRIEF DESCRIPTION OF THE DRAWINGS

FIG. 1 is a schematic diagram of hardware frame of a system for controlling device operations with a joystick in accordance with a preferred embodiment;

FIG. 2 is a schematic diagram of hardware frame of a control circuit in FIG. 1;

FIG. 3 is a flowchart of a preferred method for controlling device operations with a joystick in accordance with a preferred embodiment.

### DETAILED DESCRIPTION OF THE INVENTION

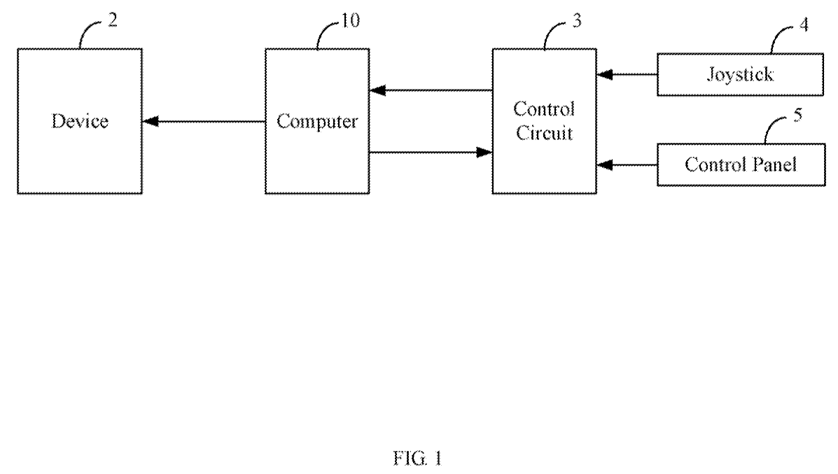

FIG. 1 is a schematic diagram of hardware frame of a system for controlling device operations with a joystick in accordance with a preferred embodiment. The system mainly includes a device 2, a control circuit 3, a joystick 4, a control panel 5, and a computer 10. The computer 10 connects to the device 2, while the joystick 4 and the control panel 5 connects to the computer 10 through the control circuit 3.

The computer 10 is configured for configuring a predetermined data format of data transmissions between the computer 10 and the circuit 3. The predetermined data format includes: representing a switch status with a binary bit; and representing an analog signal with two binary bits. The computer 10 may be a personal computer (PC).

The device 2, may be any type of machinery that allows operator-controlled steering via a joystick. For example, the device 2 may be a coordinate measuring machine.

The joystick 4 is used for controlling directional inputs of the device 2 via a forward directional input, a backward directional input, a left directional input, a right directional input, and a rotational input of the joystick 4 (when the joystick is turned/spun clockwise or anti-clockwise). The joystick 4 is configured for receiving the directional inputs and for generating joystick input signals accordingly.

The control panel 5 is configured for receiving switch settings and for generating switch status signals according to the switch settings. The control panel 5 includes a plurality of actuators (switches, buttons, and/or knobs) for receiving the switch settings correspondingly. The switch status signals are used to actuate (enable/disable) operational functions of the device 2. The operational functions include power on/off, pause, etc.

The control circuit 3 is configured for receiving the joystick input signals and the switch status signals, digitalizing and encoding the joystick input signals and the switch status signals into a data packet according to the predetermined data format, and sending the data packet to the computer 10. The joystick input signals include/contain/reflect the directional inputs of the joystick 4.

The computer 10 is further configured for decoding the data packet according to the predetermined data format in order to extract the switch status signals and the joystick input signals of the control panel 5 and the joystick 4 respectively. The computer 10 generates device control instructions so as to operate the device 2 according to the switch status signals and the joystick input signals. The computer 10 is further configured for sending the device control instructions to the device 2.

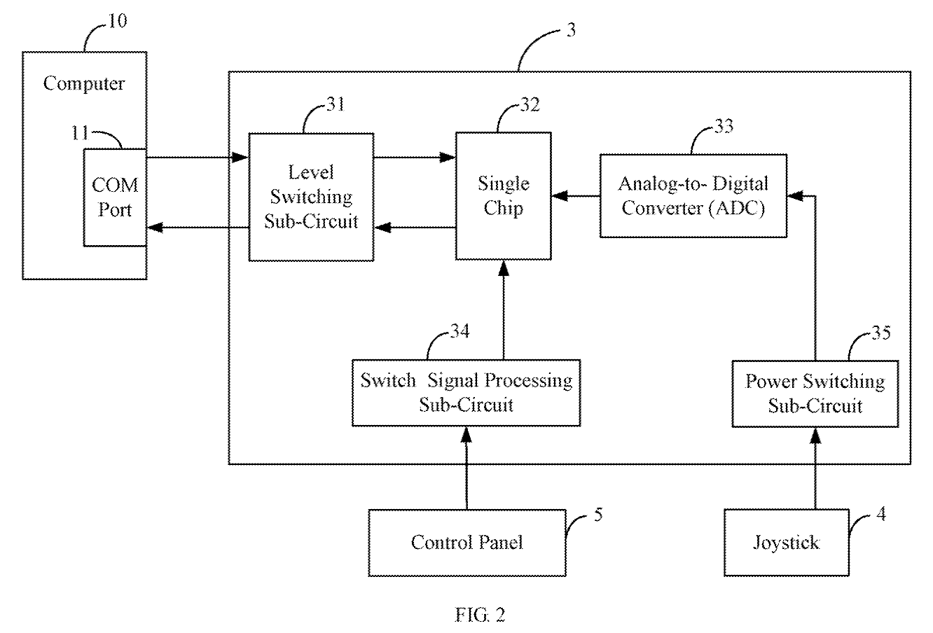

FIG. 2 is a schematic diagram of hardware frame of the control circuit in FIG. 1. The control circuit 3 includes a single chip 32, a level switching sub-circuit 31, an analog-to-digital converter (ADC) 33, a switch signal processing sub-circuit 34, and a power switching sub-circuit 35.

The single chip 32 connects to a serial communication port (COM port) 11 of the computer 10 via the level switching sub-circuit 31. The single chip 32 may be a Microprocessor Control Unit such as series 51 (MCU-51), for example a signal chip 8051. The level switching sub-circuit 31 is configured for converting positive negative logic level between the computer 10 and the single chip 32. The level switching sub-circuit 31 may be a Max232 chip or any other converter chip that is full RS-232 or RS-485 compliance.

The power switching sub-circuit 35 connects the joystick 4 to the ADC 33. The power switching sub-circuit 35 is configured for receiving the joystick input signals, amplifying and regulating the joystick input signals, and then sending the joystick input signals to the ADC 33. The joystick input signals include/contain/reflect the directional inputs of the joystick 4. The power switching sub-circuit 35 may be a comparison operational amplifier LF347.

The ADC 33 connects the power switching sub-circuit 35 to the single chip 32. The ADC 33 is configured for converting the joystick input signals to joystick digital signals and for sending the joystick digital signals to the single chip 32.

The switch signal processing sub-circuit 34 connects the control panel 5 to the single chip 32. The switch signal processing sub-circuit 34 is configured for receiving the switch status signals of the control panel 5 and sending the switch status signals to the single chip 32. The single chip 32 includes a plurality of flags to store the switch status signals correspondingly.

The switch signal processing sub-circuit 34 is configured for setting the flags to reflect the switch status. If a status of the switch is closed, the switch signal processing sub-circuit 34 sets the flag to “1” and if a status of the switch is opened, the switch signal processing sub-circuit 34 sets the flag to “0”.

The single chip 32 is configured for receiving the switch status signals and the joystick digital signals and for encoding the switch status signals and the joystick digital signals in the data packet according to the predetermined data format. Metadata is also configured in the data packet and sent to the computer 10. For example, the metadata attached to a header and/or a trailer of the data packet contains information about the data packet, including an identification of the data packet. The computer 10 determines whether the data packet received complies with the predetermined data format according to the metadata.

The computer 10 is configured for receiving the data packet via the COM port 11, decoding the data packet according to the predetermined data format in order to extract the switch status signals and the joystick input signals of the control panel 5 and the joystick 4 respectively, and sends the switch status signals and the joystick input signals to the device 2.

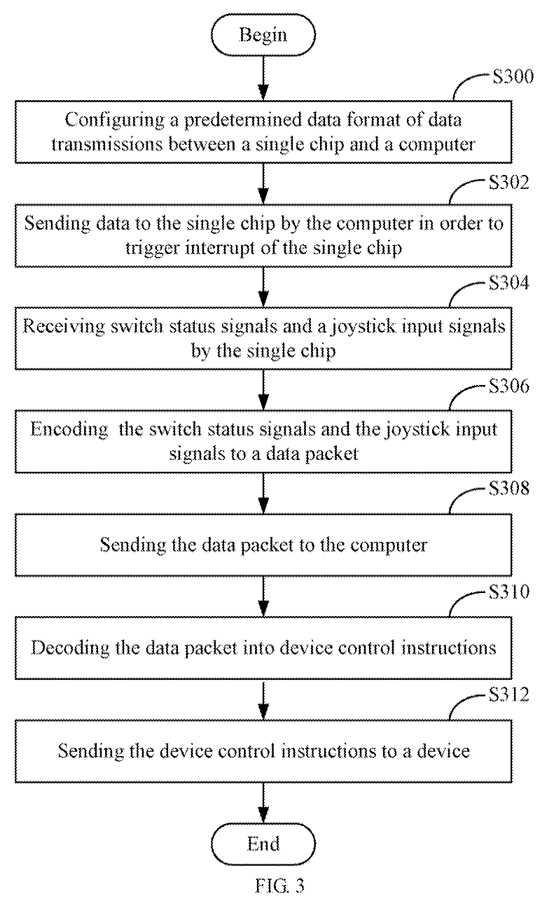

FIG. 3 is a flowchart of a preferred method for controlling device operations with a joystick in accordance with a preferred embodiment. In step S300, a user configures communication parameters of the serial communication port (COM port) 11. The communication parameters include: the COM Port Number, the data transmissions speed, etc. The communication parameters of the Com port of the single chip 32 are in accordance with the communication parameters of the Com port 11 of the computer 10. The user configures the predetermined data format between the computer 10 and the single chip 32. The predetermined data format includes: representing the switch status with a binary bit; and representing the analog signal with two binary bits.

In step S302, the computer 10 sends data in the predetermined data format to the single chip 32 in order to trigger the interrupt of the single chip 32. The data are usually instructions that signal the single chip 32 to receive the data from the joystick 4 and the control panel 5.

In step S304, the single chip 32 calls the interrupt if the single chip 32 receives the instruction, and receives the joystick input signals and the switch status signals. The joystick input signals include/contain/reflect the directional inputs of the joystick 4. The directional inputs include the forward directional input, the backward directional input, the left directional input, and the right directional input. The power switching sub-circuit 35 receives the joystick input signals, amplifies and regulates the joystick input signals, sends the joystick input signals to the ADC 33. The ADC 33 then converts the joystick input signals to the joystick digital signals, and sends the joystick digital signals to the single chip 32.

In step S306, the single chip 32 encodes the joystick digital signals and the switch status signals to the data packet according to the predetermined data format.

In step S308, the single chip 32 configures the metadata of the data packet and sends the data packet to the computer 10. The metadata is attached to the header and/or the trailer of the data packet that contains the information about the data packet, including the identification of the data packet.

In step S310, the computer 10 receives the data packet and determines whether the data packet received complies with the predetermined data format according to the metadata. If the data packet received complies with the predetermined data format, the computer 10 decodes the data packet according to the predetermined data format in order to extract the switch status signals and the joystick input signals of the control panel 5 and the joystick 4 respectively, and generates the device control instructions so as to operate the device 2. Otherwise, the computer 10 reports error information to the user and receives another data packet again.

In step S312, the computer 10 sends the device control instructions to the device 2.

It is to be understood that other embodiments may be utilized and structural changes may be made without departing from the scope of the present invention.

What is claimed is:

1. A system for controlling device operations with a joystick, the system comprising a computer connecting to the device, a joystick and a control panel connecting to the computer through a control circuit, wherein:
the computer is configured for configuring a predetermined data format of data transmissions between the computer and the control circuit;
the control circuit is configured for receiving switch status signals of the control panel and joystick input signals, digitalizing and encoding the switch status signals and the joystick input signals to a data packet according to the predetermined data format, and sending the data packet to the computer, the joystick input signals reflecting directional inputs of the joystick, the directional inputs including a backward directional input, a forward directional input, a left directional input, a right directional input, and a rotational input;
the joystick is configured for receiving the directional inputs and for generating the joystick input signals accordingly; and
the computer is further configured for decoding the data packet according to the predetermined data format in order to extract the switch status signals and the joystick input signals for generating device control instructions so as to operate the device.

2. The system of claim 1, wherein the control circuit comprises a single chip and a level switching sub-circuit, the single chip is configured for encoding the joystick input signals to the data packet according to the predetermined data format and sending the data packet to the computer via the level switching sub-circuit.

3. The system of claim 2, wherein the control circuit further comprises an analog-to-digital converter (ADC) for converting the joystick input signals to joystick digital signals and sending the joystick digital signals to the single chip.

4. The system of claim 3, wherein the control circuit further comprises a power switching sub-circuit for receiving the joystick input signals, amplifying and regulating the joystick input signals and sending the joystick input signals to the ADC.

5. The system of claim 2, wherein the control panel is configured for receiving switch settings and for generating switch status signals according to the switch settings.

6. The system of claim 5, wherein the control circuit further comprises a switch signal processing sub-circuit for receiving the switch status signals from the control panel and sending the switch status signals to the single chip.

7. A computer-based method for controlling device operations with a joystick, the method comprising the steps of:
configuring a predetermined data format of data transmissions between a computer and a control circuit;
receiving switch status signals from a control panel and joystick input signals by the control circuit, the joystick input signals reflecting directional inputs of the joystick, the directional inputs including a backward directional input, a forward directional input, a left directional input, a right directional input, and a rotational input;
encoding the joystick input signals and the switch status signals into a data packet according to the predetermined data format and sending the data packet to the computer; and
decoding the data packet by the computer according to the predetermined data format in order to extract the joystick input signals and the switch status signals for generating device control instructions so as to operate the device connected to the computer.

8. The method of claim 7, wherein the receiving step comprises the steps of:
amplifying and regulating the joystick input signals; and
converting the joystick input signals to joystick digital signals.
